(19) United States
(12) Patent Application Publication
(10) Pub. No.: US 2026/0223275 A1
(43) Pub. Date: Jul. 30, 2026

(54) PLASMA JET DEVICE

(71) Applicants: ECOLE POLYTECHNIQUE, PALAISEAU (FR); CENTRE NATIONAL DE LA RECHERCHE SCIENTIFIQUE, PARIS (FR); SORBONNE UNIVERSITE, Paris (FR)

(72) Inventors: Antoine ROUSSEAU, Paris (FR); Joseph YOUSSEF, MASSY (FR)

(21) Appl. No.: 19/145,193

(22) PCT Filed: Jan. 3, 2024
(86) PCT No.: PCT/EP2024/050083

§ 371 Date: Jul. 1, 2025

(30) Foreign Application Priority Data
Jan. 5, 2023 (FR) FR2300133

(51) Int. Cl. H05H 1/48

(52) U.S. Cl. CPC H05H 1/486

(57) ABSTRACT

A cold atmospheric-pressure plasma jet device (3) has at least one capillary tube (20) with at least one noble-gas feed inlet (22), a plasma generation zone (24), and at least one plasma outlet (26). The capillary tube has, downstream of the plasma generation zone and upstream of a distal part of the capillary tube, a portion (60) having an enlarged cross-section, preferably the portion having the enlarged cross-section having a width-to-height ratio between 0.1 and 1000, the width corresponding to the maximum inner diameter of the portion having the enlarged cross-section.

### TECHNICAL FIELD

The present invention relates to cold-atmospheric-plasma jet devices. In particular, the present invention relates to the field of cold plasmas employed in cosmetic or medical applications, in particular cutaneous applications such as the treatment of cancer cells, the cicatrization or sterilization of wounds, for example chronic or acute post-operative wounds, or in the context of a graft, post-graft to promote cicatrization and prevent infections or pre-graft to prepare the skin.

### PRIOR ART

Use of cold plasma, produced from a noble gas, conventionally helium or argon, subjected to an electric discharge delivered by a high-voltage supply, at room temperature, is well known in the field of cutaneous medical applications. The plasma propagates in pulsed, and possibly periodic, form to the outlet of a capillary, and on contact with ambient air produces reactive oxygen and nitrogen species which, together with the electric field, are responsible for the biological effects of the cold plasmas.

Treatment of the skin with the cold-atmospheric-plasma technique has proved beneficial in treatments of skin wounds, pruritus and skin infections. In particular, it is known that plasma accelerates cicatrization of wounds by promoting re-epithelialization, by reducing inflammation through activation of the protective mechanisms of the body and mobilization of immune cells to the wound area, by activating fibroblasts that induce actin cytoskeleton rearrangement and promote matrix synthesis, by activating cicatrizing cytokines and growth factors in fibroblasts and keratinocytes, and by inducing neovascularization and the production of pro-angiogenic proteins in endothelial cells.

The use of cold plasma has the advantage of requiring no direct contact and of not causing the patient any pain. In addition, treatment times are relatively short, and no allergic reactions, bacterial resistance, or other side effects have been observed so far.

Furthermore, a number of studies have shown that bacteria, fungi, biofilms, viruses and spores can be killed very effectively by means of cold plasma (biocidal activity).

However, the European-standard plasma-generating devices currently on the market do not allow the plasma dose and power applied to a given area of skin to be controlled. In addition, these devices do not allow the area of application of the plasma to be modified either. In particular, currently known devices only allow practitioners to control the length of application of the plasma, because the power delivered and the distribution of the plasma are non-uniform. The application of a treatment based mainly on a length criterion creates a great deal of uncertainty and results in treatment non-reproducibility.

U.S. Pat. No. 8,961,888 discloses an atmospheric-pressure plasma generator having a plasma generation zone of increased volume in order to allow a large area to be treated, the plasma generation zone being made of an insulating material so as to stabilize plasma formation throughout the plasma generation zone. U.S. Pat. No. 8,961,888 specifies that the plasma generation zone may be made of sintered ceramic, which material is resistant enough to withstand the plasma thus generated.

US 2011/0042008 describes a plasma generator for generating a larger volume of plasma, in which the electric discharge behind the generation of the plasma is stabilized.

US 2010/0147464 describes a plasma treatment apparatus comprising, inter alia, an electrode formed from a conductive layer covered with an insulating substrate, the substrate being made of sintered ceramic. The apparatus described in US 2010/0147464 makes it possible to obtain a plasma treatment apparatus that is more resistant to the instabilities of electric discharges, at a lower cost.

US 2009/0016941 describes an electrode device for plasma discharge allowing improved energy efficiency.

### SUMMARY OF THE INVENTION

There is a real need for a device for facilitating cold-plasma treatment of any type of wound. In particular, there is a need for a device that will guarantee the reproducibility of a cutaneous treatment and will allow the treatment to be adapted to each type of wound, especially wounds of large area. There is also a real need for a device that will allow the length of a cold-plasma treatment to be minimized and its safety to be guaranteed.

The invention aims to meet all or some of these needs.

### SUMMARY OF THE INVENTION

### Plasma Diffuser

According to a first aspect of the invention, the invention relates to a cold-atmospheric-plasma jet device comprising:
at least one capillary tube comprising at least one noble-gas supply inlet, a plasma generation zone, and at least one plasma outlet;
at least one plasma diffuser placed on the outlet path of the capillary tube, which is positioned so that the plasma generated in the plasma generation zone passes through the plasma diffuser, the plasma diffuser being made of a porous material the median pore diameter of which is advantageously between 0.1 μm and 5 mm, better still greater than 1 μm and less than 1 mm, and even better still greater than 10 μm and less than 500 μm.

A device according to the invention allows uniform diffusion of the plasma. It also allows wounds of large area to be treated easily, and the application time to be decreased.

In particular, the presence of the plasma diffuser on the outlet path of the capillary tube makes it possible to treat areas ranging from 1 to 50 cm², uniformly, in a single plasma pulse. Specifically, the presence of the plasma diffuser at the outlet of the capillary tube may make it possible to multiply by a factor of 1000 the area to which the generated plasma is applicable, compared with a device not comprising any diffuser element.

Lastly, use of a device according to the invention makes it possible to lower consumption of noble gas. In particular, such a device advantageously makes it possible to limit losses during the ejection of the plasma from the device.

By capillary tube, what is meant is a tube in which the cold-plasma jet is created and propagates.

A plasma diffuser promotes the increase in the cross section of the plasma jet.

The median pore diameter of the plasma diffuser may be greater than 0.1 μm and less than 5 mm, better still greater than 1 μm and less than 1 mm, better still greater than 10 μm and less than 500 μm, better still greater than 40 μm and less than 100 μm, and better still greater than 50 μm and less than 80 μm.

The plasma diffuser may have a thickness between 100 μm and 5 cm, better still between 500 μm and 1 cm, and even better still between 800 μm and 0.5 cm.

The thickness of the plasma diffuser may be variable.

Preferably, the thickness of the plasma diffuser remains constant.

The plasma diffuser may be made of a dielectric, semiconductor, metal or metal covered with a dielectric, or a combination of these materials, the plasma diffuser preferably being made of a dielectric.

In one embodiment of the invention, the plasma diffuser is made of sintered ceramic, and preferably of sintered glass, for example comprising high-k materials such as alumina or perovskites.

The plasma diffuser may lie in a plane perpendicular to the direction of propagation of the plasma in the capillary tube.

In one embodiment, a plurality of plasma diffusers are placed on the outlet path of the capillary tube and are positioned so that plasma generated in the plasma generation zone passes through the plasma diffusers in succession.

The capillary tube may comprise a distal portion, comprising the plasma outlet, which is flared. The flared distal portion may extend over a length, in the direction of propagation of the plasma, less than or equal to 20 cm, preferably less than or equal to 10 cm, and better still less than or equal to 5 cm. The ratio of the maximum diameter of the distal portion to the minimum diameter of the distal portion may be between 1 and 100.

These diameters are measured perpendicular to the direction of propagation of the plasma and are inside diameters, i.e. the walls of the tube are not taken into account when measuring them.

Preferably, the plasma diffuser is positioned in the flared distal portion of the capillary tube, perpendicular to the direction of propagation of the plasma in the capillary tube.

The plasma diffuser thus positioned allows plasma of larger size to be stabilized. Moreover, the plasma diffuser prevents air from diffusing back into the flared distal portion, thus improving the stability and uniformity of the plasma passing through the diffuser.

The plasma diffuser may be positioned at the end of the flared distal portion, or in other words the plasma diffuser may be positioned in the distal portion of the capillary tube having the largest diameter.

The capillary tube may comprise a wall of set or variable thickness. In the particular case of a wall of variable thickness, the wall of the distal portion may be wider than the wall of the plasma generation zone. The wall of the distal portion may have a thickness between 0.1 mm and 5 mm. The ratio of the thickness of the wall of the plasma generation zone to the thickness of the distal portion may be between 0.1 and 10.

A device according to the invention may comprise more than two plasma outlets and/or more than two capillary tubes. Preferably, the number of plasma outlets is between 1 and 100, preferably between 1 and 50, and better still between 1 and 10.

In one embodiment of the invention, the device comprises a capillary tube comprising 3 plasma outlets, each plasma outlet comprising one plasma diffuser.

In one preferred embodiment of the invention, the device comprises a plurality of capillary tubes, each capillary tube comprising 3 plasma outlets, each of the plasma outlets comprising one plasma diffuser, each capillary tube preferably comprising one noble-gas supply inlet.

A plasma diffuser may be positioned on the outlet path of each plasma outlet, the plasma device comprising as many plasma diffusers as there are plasma outlets. Alternatively, a plasma diffuser may be positioned on the outlet path of a plurality of plasma outlets.

According to another variant of the invention, a plurality of successive plasma diffusers may be positioned on the outlet path of each plasma outlet.

The plasma diffuser may be raised to a predetermined potential. Preferably, the plasma diffuser may be at a floating potential or connected to an active or passive electrode, making it possible to modulate the propagation of the plasma.

### Buffer Volume

According to a second aspect of the invention, the invention relates to a cold-atmospheric-plasma jet device comprising:
at least one capillary tube comprising at least one noble-gas supply inlet, a plasma generation zone, and at least one plasma outlet;
   the capillary tube comprising, downstream of the plasma generation zone and upstream of a distal portion of the capillary tube, a segment of enlarged cross section, the segment of enlarged cross section preferably having a width/height ratio between 0.1 and 1000, preferably between 0.5 and 100, and better still between 0.8 and 10, the width corresponding to the maximum inside diameter of the segment of enlarged cross section.

The width corresponds to the maximum inside diameter of the segment of enlarged cross section, this diameter being measured perpendicular to the direction of propagation of the plasma in the tube. The diameter is said to be an inside diameter, i.e. the walls of the tube are not taken into account.

The segment of enlarged cross section forms a buffer volume allowing plasma ignition voltage, i.e. the voltage that must be applied to an electrode to allow plasma to be formed in the plasma generation zone of the capillary tube, to be decreased by about 20%. Propagation of the plasma then requires less energy. In addition, the electromagnetic noise generated is reduced.

The segment of enlarged cross section advantageously opens onto a bottleneck in the direction of the plasma outlet.

Furthermore, such a segment of enlarged cross section makes it possible to better control the plasma dose, i.e. the amount of plasma energy transferred out of the device, and thus to control application of the plasma to the area to be treated.

The device may comprise a sensor measuring pressure in the segment of enlarged cross section and/or speed of propagation of the plasma in the capillary tube.

The segment of enlarged cross section may be located at a distance between 0 cm and 10 cm from the plasma outlet, preferably between 0 cm and 7 cm, and more preferably between 0 cm and 5 cm.

The diameter of the segment of enlarged cross section may be variable, and in particular it may increase and then decrease from upstream to downstream.

The interior volume of the segment of enlarged cross section may have a shape adapted to the flow of the gas, i.e. that is substantially spherical, better still spherical, substantially ellipsoidal, better still ellipsoidal, substantially cylindrical, better still cylindrical, or substantially parallelepipedal, better still parallelepipedal.

Of course, this list is non-limiting. The interior volume of the segment of enlarged cross section may have other geometric shapes. In particular, the shape may or may not have an axis or a center of symmetry, and may be a combination of the aforementioned shapes.

The interior volume of the segment of enlarged cross section may be between 0.2 cm³ and 250 cm³, preferably between 0.5 cm³ and 200 cm³, and better still between 1 cm³ and 25 cm³.

The minimum diameter of the capillary tube may be the diameter of the bottleneck, i.e. the diameter of the outlet of the segment of enlarged cross section, in the direction of propagation of the plasma.

Preferably, the diameter of the inlet of the segment of enlarged cross section is greater than the diameter of the bottleneck.

The bottleneck may be raised to a predetermined potential. The predetermined potential may be selected so as to keep the cold plasma in the segment of enlarged cross section, the predetermined potential being modified to allow movement of the cold plasma toward the plasma outlet.

In one particular embodiment, the capillary tube comprises a plurality of plasma outlets, the segment of enlarged cross section comprising a plurality of bottlenecks each leading to one plasma outlet.

Alternatively, the capillary tube comprises a plurality of plasma outlets, one segment of enlarged cross section being provided in the capillary tube for each of the plasma outlets.

The ratio of the maximum diameter of the segment of enlarged cross section to the diameter of the supply inlet and/or the maximum diameter of the segment of enlarged cross section to the diameter of the bottleneck may be between 1 and 1000, preferably between 1 and 500, and better still between 1 and 50.

The ratio of the maximum diameter of the segment of enlarged cross section to the minimum diameter of the capillary tube may be between 2 and 40.

In one particular embodiment, the distal portion is flared. The capillary tube may have a cross section of minimum diameter between the segment of enlarged cross section and the flared distal portion.

Alternatively, the diameter of the distal portion of the capillary tube remains constant.

The segment of enlarged cross section may have a wall of smaller thickness than a wall of the distal portion.

The ratio of the thickness of the wall of the distal portion to the thickness of the wall of the segment of enlarged cross section may be between 1 and 4.

The segment of enlarged cross section may be made of a different material to the capillary tube. Preferably, the segment of enlarged cross section is made of the same material as and integrally formed with the capillary tube.

The capillary tube comprising at least one noble-gas supply inlet, at least one plasma outlet, a plasma generation zone and a segment of enlarged cross section may be manufactured by molding or blow molding, or even by additive manufacturing.

The capillary tube comprising at least one noble-gas supply inlet, at least one plasma outlet, a plasma generation zone and a segment of enlarged cross section may be made of glass or any insulating material with a high dielectric constant.

The capillary tube comprising at least one noble-gas supply inlet, at least one plasma outlet, a plasma generation zone and a segment of enlarged cross section may be monolithic.

The maximum diameter of the capillary tube is preferably less than 3 mm, and more preferably less than 1 mm.

The capillary tube may be partially removable. In particular, the distal portion may be removable. Preferably, the downstream portion of the plasma generation zone is removable, i.e. it may be disengaged/unscrewed from the portion comprising the plasma generation zone and the noble-gas supply inlet.

The removable downstream portion and the upstream portion comprising the plasma generation zone and the noble-gas supply inlet may have complementary shapes. In particular, the upstream portion may have a shape that is complementary with a plurality of different removable downstream portions.

### Ignition

A device according to the invention may comprise a high-voltage electrode fastened to the exterior wall and/or to the interior wall of the capillary tube, the device being configured so that the electrode delivers a first electrical signal and a second electrical signal having two distinct frequencies, the frequency of the first electrical signal being defined so that when the electrode delivers this first electrical signal, the noble gas introduced into the capillary tube and subjected to the voltage of the first electrical signal generates the plasma, the frequency of the second electrical signal being defined so as to generate a pulse triggering propagation of the plasma toward the plasma outlet, the frequency of the second electrical signal being lower than the frequency of the first electrical signal, the ratio between the first signal frequency and second signal frequency preferably being greater than 1 and less than or equal to 1000, more preferably between 3 and 100, and better still between 5 and 50.

The second signal advantageously triggers and/or accelerates propagation of the plasma in the capillary tube.

The second signal makes it possible in particular to adapt the plasma dose ejected from the device.

By plasma dose, what is meant is the amount of plasma energy transmitted to the target.

In one embodiment of the invention, the first electrical signal is a carrier wave modulated by the second signal. Such an embodiment advantageously makes it possible to substantially decrease the electromagnetic noise generated by a plasma jet device.

In another embodiment, the first and second electrical signals are delivered via a first electrode and a second electrode, respectively, the first electrode being positioned upstream of the second electrode, in the direction of propagation of the plasma.

The second electrode may be positioned downstream of the segment of enlarged cross section in the direction of propagation of the plasma.

The second electrode may be positioned in the distal portion of the capillary tube.

In one particular embodiment, the device may comprise at least two second electrodes, for example positioned in the bottleneck of a device according to the invention comprising a segment of enlarged cross section, and in the distal portion of the capillary tube. The first and/or second electrode(s) may be positioned outside or inside the wall of the device.

The device may comprise a switch, the second electrical signal being emitted when the switch is closed. Thus, the second electrical signal may be delivered only when a switch is open, for example when a push button is pressed.

The first signal may be a DC, AC, pulsed or hybrid signal.

The second signal may be a DC, AC or pulsed signal.

Advantageously, a device according to the invention makes it possible to better control the plasma dose output from the device.

### Parameter Control

A device according to the invention may comprise one or more sensors, for example selected from: a voltage sensor, a power sensor, a frequency sensor, a flow-rate sensor, a distance sensor or a thermal sensor.

A sensor may be configured to measure the power of the plasma output from the plasma diffuser and/or output from the plasma generator.

A sensor may be configured to measure a voltage between the plasma output from the plasma diffuser and an area to which the plasma is intended to be applied or between the plasma output from the plasma generator and an area to which the plasma is intended to be applied.

A sensor may be configured to measure temperature during application of the cold plasma to the area to which the plasma is intended to be applied.

Preferably, the device according to the invention further comprises a control module configured to analyze the measurements generated by one or more sensors.

The control module may be configured to modify, depending on analyzed measurements generated by one or more sensors, a voltage or frequency of an electrical signal delivered for the purposes of generation of the plasma in the plasma generation zone, a voltage or frequency of an electrical signal delivered for the purposes of triggering or accelerating propagation of the plasma in the capillary tube, a plasma dose ejected by the device onto the target, the target corresponding to the area to which the plasma is intended to be applied, a temperature of the plasma at the plasma outlet of the capillary tube, a pressure in the plasma generation zone, a noble-gas pressure in the capillary tube, a pressure in a segment of enlarged cross section, a noble-gas flow rate at the supply inlet.

In one embodiment, the control module displays the measurements and/or analysis of the measurements on a digital interface. An operator may then easily modify a frequency, a voltage, a pressure and/or a flow rate in order to adapt the desired plasma dose output from the device and/or select a particular plasma regime.

Cold plasmas exist in a wide variety of regimes and their discharges are of different types depending on the production conditions (diffuse jet discharges, filamentary discharges, hollow cathode discharges).

By a mode of a plasma regime, what is meant is an operating mode of the plasma allowing a particular type of discharge to be achieved.

A device according to the invention advantageously allows real-time adaptation of the delivered plasma dose, facilitating application and guaranteeing the safety of a treatment.

Preferably, a device according to the invention comprises a plurality of capillary tubes, a control module and sensors, and optionally a digital interface, the device preferably being configured so that the capillary tubes are controlled independently of one another.

### Method of Use

According to another of its aspects, the invention relates to use of a porous material, comprising pores of median diameter between 0.1 μm and 5 mm, as a plasma diffuser, preferably in a cold-plasma jet device.

The porous material may comprise pores of median diameter between 1 μm and 1 mm, better still between 10 μm and 500 μm, even better still between 40 μm and 100 μm, and even better still between 50 μm and 80 μm.

The porous material may have a thickness between 100 μm and 5 cm.

The porous material may be of variable thickness. Preferably, the porous material has a constant thickness.

The porous material may be made of a dielectric, semiconductor, metal or metal covered with a dielectric, the porous material preferably being made of a dielectric.

Preferably, the porous material is made of sintered ceramic, and preferably of sintered glass, for example comprising high-k materials such as alumina or perovskites.

A porous material according to the invention may be used as a plasma diffuser in any field of application employing cold plasmas and in particular for applications involving surface treatment or grafting or adhesive bonding or propulsion.

Preferably, the invention relates to the use of a porous material according to the invention as a plasma diffuser in devices for medical applications.

The various aspects of the invention may be combined with one another. In particular, a device according to the invention may comprise a plasma diffuser and a segment of enlarged cross section.

The terms “upstream”, “downstream”, “inlet” and “outlet” are defined relative to the direction of propagation of the noble gas and of the plasma. The terms “interior” and “exterior” and “inside” and “outside” are defined relative to the position of the plasma with respect to the device, the plasma being inside the device.

### BRIEF DESCRIPTION OF THE DRAWINGS

The invention will possibly be better understood on reading the following detailed description of non-limiting examples of implementation thereof, and on examining the appended drawing, in which:

FIG. 1 schematically shows a view of a longitudinal section of a plasma-generating device illustrating the generation of a cold plasma,

FIG. 2 schematically shows a view of a longitudinal section of a plasma jet device comprising a plasma diffuser according to the invention,

FIG. 3 shows a view of a longitudinal section of a plasma jet device comprising a plasma diffuser according to the invention,

FIGS. 4a, 4b, 4c, 4d and 4e illustrate various embodiments of a device comprising a plasma diffuser according to the invention,

FIG. 5 schematically shows the application of a plasma to an area by means of a plasma jet device,

FIG. 6 is a graph illustrating the propagation and diffusion of a plasma by means of a device according to FIG. 5;

FIG. 7 shows a plasma jet device comprising, inter alia, a segment of enlarged cross section,

FIG. 8 shows a plasma jet device comprising a segment of enlarged cross section according to the invention,

FIG. 9 is a schematic showing a see-through view from below of a device comprising a segment of enlarged cross section according to the invention, and

FIG. 10 is one example of a device according to the invention comprising a segment of enlarged cross section and a plasma diffuser.

In the rest of the description, elements that are identical or have identical functions will be designated with the same reference sign. Their description is not repeated with reference to each of the figures, only the main differences between the embodiments being mentioned.

### DETAILED DESCRIPTION

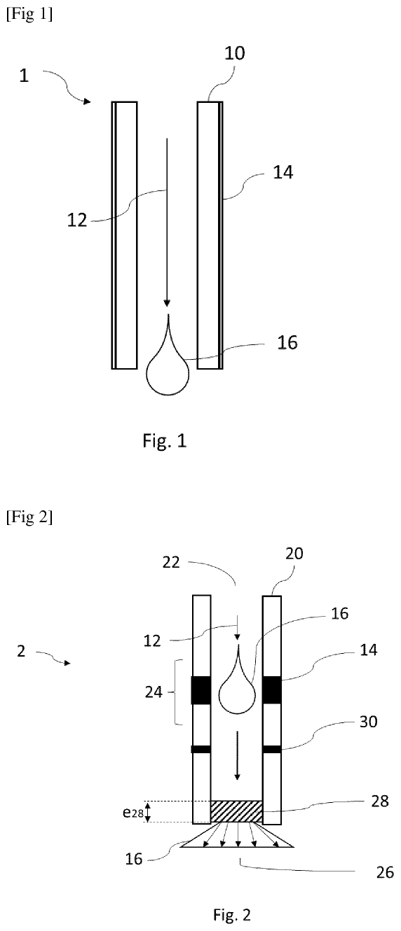

FIG. 1 illustrates the operation of a prior-art plasma jet device 1.

Conventionally, the cold plasma is created in a dielectric tube 10 comprising a noble gas 12 at room temperature, an electrode 14 fastened to the dielectric tube 10 creating an electromagnetic field. The cold plasma 16 is generated as a result of the noble gas 12 being subjected to the electromagnetic field. A cold-plasma jet 16 is ejected from the device 1.

FIG. 2 schematically shows a view of a longitudinal section of a plasma jet device 2 according to the invention comprising a plasma diffuser 28.

The device 2 comprises, inter alia, a capillary tube 20 comprising at least one noble-gas supply inlet 22 for supply of a noble gas 12, a plasma generation zone 24, at least one plasma outlet 26, and a plasma diffuser 28 placed on the outlet path of the capillary tube, which is positioned so that the plasma 16 generated in the plasma generation zone 24 passes through the plasma diffuser 28, the plasma diffuser being made of a porous material the median pore diameter of which is between 0.1 μm and 5 mm, preferably between 1 μm and 1 mm, and better still between 10 μm and 0.5 μm.

On exiting the tube, the plasma 16 propagates uniformly over a large area of application.

The noble gas 12 may be helium, argon, neon or a mixture of gases, for example argon with 5% oxygen. Preferably, the noble gas is helium.

The flow rate of noble gas may be between 0.2 L/min and 5 L/min, and preferably about 1 L/min.

At least one high-voltage electrode 14 is fastened to the exterior wall of the capillary tube, allowing generation of the plasma in the plasma generation zone 24 from the noble gas 12 introduced via the supply inlet 22.

The electrode is able to deliver a sinusoidal electrical signal with a frequency between 50 Hz and 100 kHz, and preferably of about 10 kHz, and a voltage between 1 kV and 30 kV, and preferably between 2 kV and 4 kV.

A second electrode 30 may be fastened to the wall of the capillary tube 20, downstream of the first electrode 14, in the direction of propagation of the plasma.

The second electrode may be a low-voltage or high-voltage electrode. Preferably, the second electrode is a low-voltage electrode, thus limiting the electromagnetic noise generated by the device 2.

The second electrode advantageously triggers or accelerates propagation of the cold plasma 16 by capillary action in the capillary tube 20.

The second electrode may be controlled by a control module (not shown).

In particular, the control module may be configured to allow a user to adapt the plasma dose output from the device, by controlling the voltage delivered by the one or more electrodes. For example, the control module may be configured so that when a switch is closed, a voltage is delivered via the second electrode, and when the switch is open, no voltage is delivered via the second electrode.

In one particular embodiment of the invention, a single electrode 14 delivers a first electrical signal and a second electrical signal, for example via a modulated signal, comprising a carrier of frequency f and a signal of lower frequency, the frequency of the lowest frequency signal.

The high-frequency carrier allows the cold plasma to be generated, and the lower frequency signal allows propagation and/or accelerated propagation of the cold plasma to be triggered.

The one or more electrodes 14; 30 are preferably positioned against the exterior surface of the wall of the capillary tube. The plasma thus produced is isolated from the one or more electrodes by the thickness of the wall of the capillary tube and may be brought into contact with a living organism without danger of electric shock or heating.

The porous material 28 may comprise pores the median diameter of which is between 1 μm and 5 mm.

The thickness of the porous material e₂₈ may be between 100 μm and 5 cm.

The thickness of the porous material e₂₈ may be variable. Preferably, the thickness of the porous material e₂₈ remains constant.

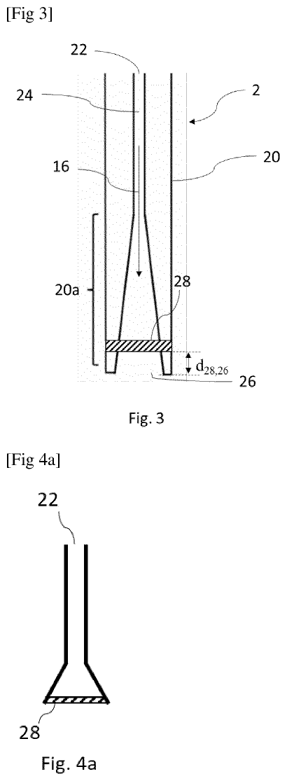

FIG. 3 illustrates another embodiment of a device 2 according to the invention. The device differs from the example shown in FIG. 2 in particular in that it comprises a flared distal portion 20a, the plasma diffuser 28 being positioned in this flared distal portion 20a. The combination of a flared distal portion and a plasma diffuser made of a porous material according to the invention makes it possible to considerably increase the area of application of the cold plasma output from the device.

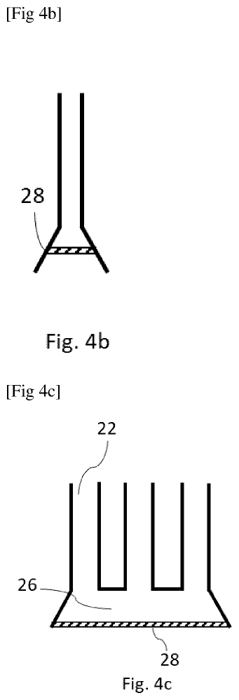

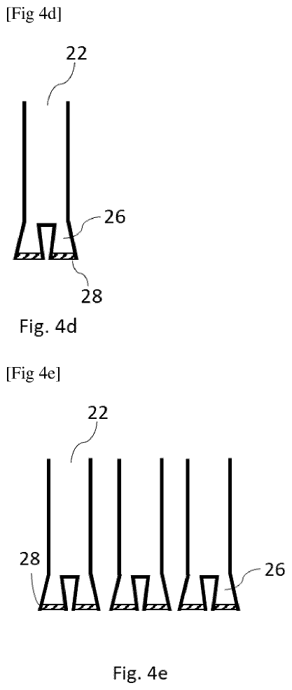

The plasma diffuser 28 may be placed at the distal end of the capillary tube, as for example shown in FIGS. 4a, 4c and 4d.

Alternatively, the plasma diffuser 28 may be placed in the distal portion of the capillary tube, inside the capillary tube, and not necessarily on its periphery, as shown in FIG. 4b. In particular, a distance d_{28,26} of less than or equal to 10 mm may separate the plasma outlet 26 from the porous material 28.

A device according to the invention may comprise a plurality of noble-gas supply inlets 22, possibly a plurality of plasma generation zones 24, and one plasma outlet 28. Such an example is shown in FIG. 4c.

A device according to the invention may comprise a plurality of plasma outlets 26, and one plasma diffuser 28 may be placed on the path of each of the outlets 26 of the capillary tube, as illustrated in FIG. 4d.

The number of plasma outlets 26 is not limited to 1 or 2. A device according to the invention may comprise more than two plasma outlets, in particular a capillary tube 20 may comprise 3 plasma outlets. Preferably, the number of plasma outlets is between 1 and 100.

A device according to the invention may accommodate plasma outlets, or plasma heads, that are modular, removable and interchangeable. In particular, the plasma outlets may be mechanically fastened to the capillary tube.

A device according to the invention may comprise a plurality of capillary tubes 20, as illustrated in FIG. 4e.

A device according to the invention comprising a plurality of capillary tubes 20 may comprise capillary tubes that differ from one another. The capillary tubes 20 may differ from one another in their number of supply inlets 22, their number of plasma outlets 26, the presence of one or more plasma diffusers 28, the presence of a segment of enlarged cross section 60, the maximum or minimum diameter of the capillary tube, the thickness of the wall of the capillary tube, or the presence of a flared distal portion 20a. This list is non-limiting.

FIG. 6 is a graph illustrating the propagation of a plasma in a capillary tube 20 comprising a porous material 28′ on the plasma outlet path.

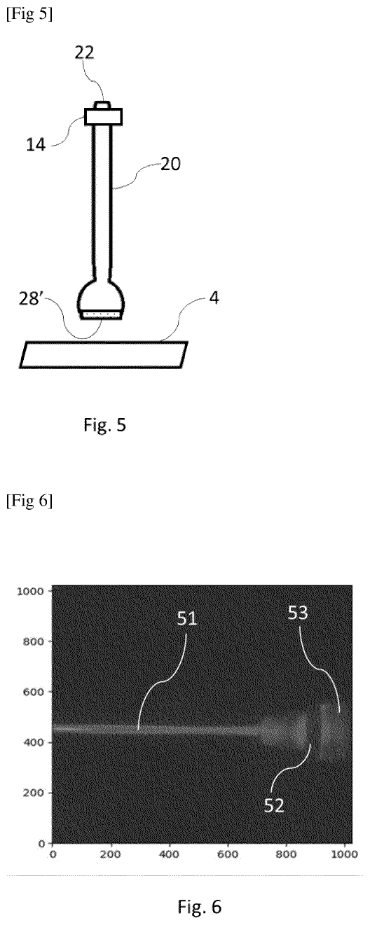

The results shown in the graph were obtained by experiment, using a device as shown in FIG. 5, in which the porous material 28′ comprises pores the median diameter of which is between 40 μm and 100 μm.

During the experiment, the plasma was generated in a capillary tube 20 subjected to an electromagnetic field by means of an annular high-voltage copper electrode 14, the plasma being applied to a glass target area 4 under which an aluminum strip was deposited, a space of 5 mm separating the plasma outlet 26 of the capillary tube from the target area 4, the electrode 14 generating an electrical signal with a voltage of about 4.4+/−0.30 kV, at a frequency of 15 kHz.

The x- and y-axes of the graph of FIG. 6 represent a number of pixels, one pixel being equal to 50 μm.

In the graph, it is in particular possible to see a first phase 51 in which the plasma propagates along the capillary tube 20, a second phase 52 in which the plasma reaches and passes through the porous material 28′, and lastly a third phase 53 in which the plasma passes beyond the porous material 28′ and is applied to the surface 4.

It may be seen that the diffusion of the plasma is uniform, and that the plasma extends over a relatively larger area.

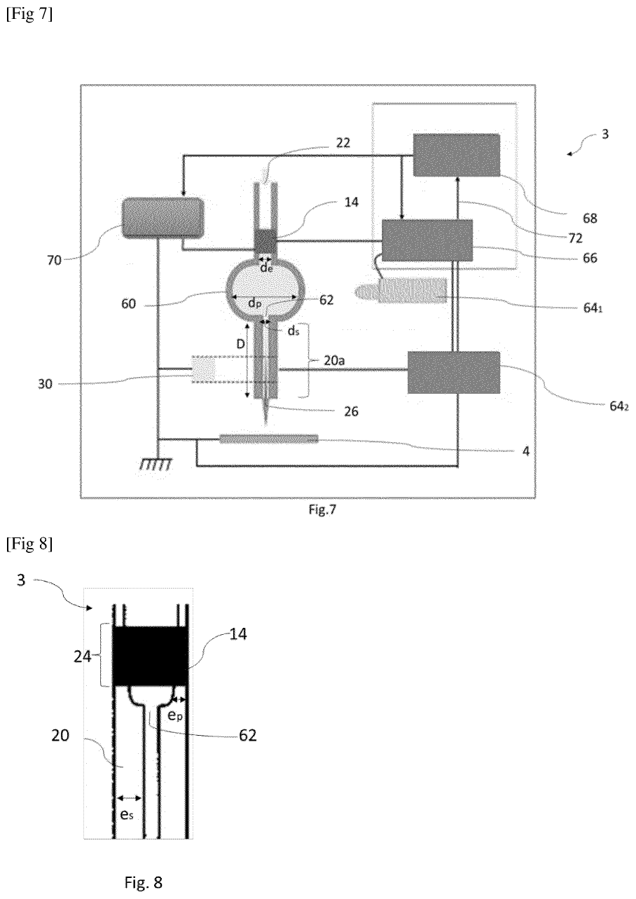

FIG. 7 shows a plasma jet device 3 according to the invention comprising a segment of enlarged cross section 60.

The device 3 shown in FIG. 7 comprises a capillary tube 20 comprising a noble-gas supply inlet 22, a plasma generation zone, the plasma being generated by the electrode 14, and a plasma outlet 26; the capillary tube comprising, downstream of the plasma generation zone and upstream of a distal portion of the capillary tube 20a, a segment of enlarged cross section 60.

In one embodiment, the segment of enlarged cross section 60 may comprise the plasma generation zone 24.

The ratio D_{p,max}/hₚ of the maximum diameter to the height of the segment of enlarged cross section 60 may be between 0.1 and 100.

The segment of enlarged cross section advantageously opens onto a bottleneck 62 in the direction of the plasma outlet 26.

The segment of enlarged cross section 60 may be located at a distance D from the plasma outlet of between 0 cm and 10 cm.

The diameter dₚ of the segment of enlarged cross section may be variable, and in particular it may increase and then decrease from upstream to downstream. In one embodiment, the diameter dₚ of the segment of enlarged cross section may decrease from upstream to downstream.

The interior volume of the segment of enlarged cross section may have a shape that is substantially spherical, better still spherical, substantially ellipsoidal, better still ellipsoidal, or substantially cylindrical, better still cylindrical. These examples are non-limiting.

The interior volume of the segment of enlarged cross section may be between 0.2 cm³ and 250 cm³.

The minimum diameter of the capillary tube may be the diameter dₛ of the bottleneck.

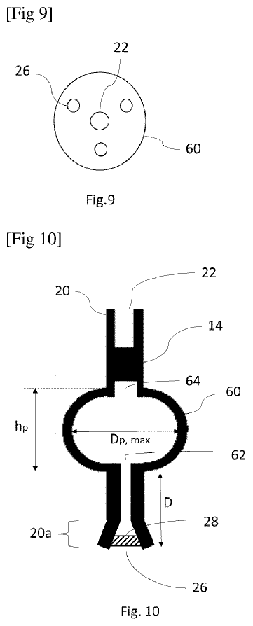

In one particular embodiment, the capillary tube comprises a plurality of plasma outlets, the segment of enlarged cross section comprising a plurality of bottlenecks 62 each leading to one plasma outlet. One example of such an embodiment is shown in FIG. 9. FIG. 9 shows a view from below of a capillary tube 20 comprising three plasma outlets 26 and one segment of enlarged cross section 60.

Alternatively, one segment of enlarged cross section is provided in the capillary tube for each of the plasma outlets.

The ratio of the maximum diameter of the segment of enlarged cross section to the inlet diameter dₑ of the segment of enlarged cross section may be between 1 and 1000, preferably between 1 and 500, and better still between 1 and 50.

The ratio of the maximum diameter of the segment of enlarged cross section to the diameter dₛ of the bottleneck may be between 1 and 1000, preferably between 1 and 100, and better still between 1 and 50.

Preferably, the diameter dₑ of the inlet of the segment of enlarged cross section is greater than the diameter dₛ of the bottleneck.

This advantageously allows the speed of propagation of the plasma in the distal portion of the capillary tube to be increased, via the venturi effect.

The diameter of the distal portion 20a of the capillary tube may remain constant, as shown in FIG. 7.

In one particular embodiment, the distal portion 20a is flared.

The segment of enlarged cross section may have a wall of thickness eₚ smaller than the thickness eₛ of a wall of the distal portion, as in the example of FIG. 8.

The ratio eₛ/eₚ of the thickness eₛ of the wall of the distal portion to the thickness eₚ of the wall of the segment of enlarged cross section may be between 1 and 4. The maximum diameter of the capillary tube is less than 3 mm, and preferably less than 1 mm.

A device according to the invention may comprise sensors 641, 642, in particular optical sensors 641, thermal sensors or voltage sensors 642.

The sensors 641, 642 may deliver measurements to a control module 66 that is able to adapt, through a feedback mechanism, the plasma dose transmitted out of the device, preferably by adapting treatment time, power (via the voltage and/or frequency delivered by a high-voltage supply 70 to the electrode 14 used to generate the plasma), power (via the voltage and/or frequency delivered by the high-voltage supply to another electrode fastened to the wall of the capillary tube, and preferably to the exterior wall, preferably downstream of the electrode used to generate the plasma, which electrode is for example configured to trigger or accelerate propagation of the plasma toward the plasma outlet) and/or the flow rate of noble gas at the noble-gas supply inlet 22.

The sensors may comprise voltage sensors measuring a difference in voltages along the capillary tube.

The sensors may comprise voltage sensors 642 measuring a difference in voltages between the capillary tube and the area to which the plasma is intended to be applied 4.

The sensors may comprise temperature sensors measuring a temperature at the plasma outlet or a temperature in an area 4 to which the plasma is intended to be applied.

The sensors may comprise flow-rate sensors measuring the flow rate of noble gas entering the supply inlet.

The sensors may comprise biosensors, i.e. sensors allowing a biochemical signal to be detected and converted into a quantifiable physical signal.

The sensors for example comprise electrocardiograms, fastened to the area 4 to which the plasma is intended to be applied.

The control module 66 is able to modify one or more parameters selected from treatment time, a power, a voltage and/or a frequency delivered by a high-voltage supply 70 to an electrode fastened to the wall of the capillary tube, and preferably to the exterior wall, and/or a flow rate of noble gas at the noble-gas supply inlet 22, making it possible to adapt the plasma dose ejected from the device.

In one particular embodiment of the invention, the control module 66 does not adapt the plasma dose ejected from the device through a feedback mechanism, but transmits the measurements delivered by the sensors or an analysis of the measurements delivered by the sensors to a control interface 68, via digital communication means 72.

The control interface 72 allows a user to manually control the plasma dose ejected from the device, and to adapt it depending on the measurements delivered by the sensors 641, 642.

In particular, the user may modify the power, voltage and/or frequency delivered by the high-voltage supply 70 to the electrode 14 used to generate the plasma, the power, voltage and/or frequency delivered by a current source to another electrode fastened to the wall of the capillary tube, and preferably to the exterior wall, preferably downstream of the electrode used to generate the plasma, which electrode is for example configured to trigger or accelerate propagation of the plasma toward the plasma outlet, and/or the flow rate of noble gas at the noble-gas supply inlet 22, and/or the distance from the plasma outlet 26 to the area 4 to which the plasma is intended to be applied.

FIG. 10 shows one example of implementation of a device according to the invention comprising a plasma diffuser 28 and a segment of enlarged cross section 60.

### Example

A comparison of four plasma jet devices was made.

The comparison made it possible to measure a maximum area over which a plasma is able to extend uniformly, via a plasma jet, when the plasma is generated and applied by means of one of the following four devices: KinPen® MED (Neoplas GmbH, Greifswald, Germany), PlasmaDerm® (CINOGY GmbH, Duderstadt, Germany), SteriPlas (Adtec Plasma Technology, Adtec Europe, Hunslow, United Kingdom) and a device according to the invention comprising a plasma diffuser.

The KinPen® MED is a portable device possessing a continuously generated medical plasma source and comprising a pen-shaped applicator delivering a cold-atmospheric-plasma jet using argon as carrier gas. The typical plasma-plume length is 8 to 12 mm with a diameter of 1 mm. The plasma jet is guided vertically in precise and arbitrary 3D movements of about 5 mm/s over the target, this leading to an average processing time of 30 to 60 s/cm². The KinPen® MED therefore delivers a non-diffused jet concentrated on one point. The effective treatment area is reduced to a few mm².

The PlasmaDerm® is a plasma device allowing large areas to be treated. It is equipped with a plurality of configurable plasma heads allowing an area of up to 27 cm² to be covered. The plasma source is based on the concept of dielectric barrier discharge (DBD). The carrier gas may be argon or air. However, in a device based on DBD, the generated plasma behaves differently between two alternations of plasma discharge and the lack of uniformity in the transferred plasma means that the user must be highly skilled. In addition, the device makes direct mechanical contact with the target.

The SteriPlas is a large castor-mounted medical device possessing an articulated arm with a treatment head that releases cold argon-based plasma toward the treatment area. The plasma torch possesses 6 electrodes and argon is used as a carrier gas to transport the gas stream to the target. The aperture of the plasma torch has a diameter of 3.5 cm, allowing a treatment area of up to 12 cm².

A device according to the first aspect of the invention makes it possible to cover an area of 1 to 50 cm² with initial propagation of a single plasma jet, in particular without the need for contact with the target.

As should now clearly be apparent, a device according to the invention allows a better propagation of the plasma. Not only is it possible to process large areas more rapidly and more uniformly, but the device also allows better adaptability and greater dosing precision. Such a device is particularly advantageous for the treatment of burns, for example of patients who have received severe burn injuries. Generally, such a device is suitable for treating any type of wound, in particular chronic wounds of different types.

It was not obvious that sintered glass in particular could be used, as a porous material, in a plasma diffuser in cold-plasma jet devices. Specifically, even if the use of sintered glass in plasma jet devices is well known in the prior art, because of its mechanical properties (such as its resistance to corrosion, wear, compression, high temperatures and chemicals) allowing it to withstand the conditions of plasma generation, it has never been envisaged to use it as a diffuser activated by a plasma jet.

The invention allows dynamic control of the plasma dose ejected from the plasma jet device and thus allows the user to better adapt each treatment depending on the wound or clinical context.

Of course, the invention is not limited to the examples of embodiment that have just been described.

In particular, a device according to the invention may include a safety system configured to control the plasma dose ejected from the device, and/or to control the delivered current, and/or to control a temperature of the plasma output from the device and/or to control a power of the plasma and/or to control a noble-gas pressure in a noble gas cylinder supplying the noble-gas supply inlet of the capillary tube and/or to control a noble-gas pressure in the capillary tube, and in particular in the segment of enlarged cross section, when the capillary tube comprises one. For example, the safety system may be a fast circuit breaker, or a microcontroller controlling the high-voltage supply of the electrode used to generate the plasma.

A device according to the invention preferably is designed with redundancy, in particular in order to comply with regulations concerning medical devices.

In particular, a device according to the invention is preferably configured to comply with all or some of the following standards: ISO 13485:2016, ISO 14971:2019, IEC 62304/A1: 2018, IEC 62366-1:2015, ISO 15223-1:2016, ISO 10993, IEC 60601-1, AAMI TIR 57, 14155:2020 (if RIPH1), DIN SPEC 91315. This list is not exhaustive.

The expressions “comprising a” and “comprising one” must be understood to be synonymous with “comprising at least one”.

1. A cold-atmospheric-plasma jet device comprising:
at least one capillary tube comprising at least one noble-gas supply inlet, a plasma generation zone, and at least one plasma outlet;
the capillary tube comprising, downstream of the plasma generation zone and upstream of a distal portion of the capillary tube, a segment of enlarged cross section.

2. The device as claimed in claim 1, the segment of enlarged cross section being located at a distance between 0 cm and 10 cm from the plasma outlet.

3. The device as claimed in claim 1, the diameter of the segment of enlarged cross section being variable.

4. The device as claimed in claim 1, wherein the interior volume of the segment of enlarged cross section has a shape that is substantially spherical.

5. The device as claimed in claim 4, the interior volume of the segment of enlarged cross section being between 0.2 cm³ and 250 cm³.

6. The device as claimed in claim 1, the minimum diameter of the capillary tube being the diameter of a bottleneck onto which the segment of enlarged cross section opens.

7. The device as claimed in claim 1, the diameter of the inlet of the segment of enlarged cross section being greater than the diameter of a bottleneck onto which the segment of enlarged cross section opens.

8. The device as claimed in claim 1,
a bottleneck onto which the segment of enlarged cross section opens being raised to a predetermined potential.

9. The device as claimed in claim 1, the capillary tube comprising a plurality of plasma outlets, the segment of enlarged cross section opening into a plurality of bottlenecks each leading to one plasma outlet.

10. The device as claimed in any of claim 1, the capillary tube comprising a plurality of plasma outlets, one segment of enlarged cross section being provided in the capillary tube for each of the plasma outlets.

11. The device as claimed in claim 1, the segment of enlarged cross section having a width/height ratio between 0.1 and 1000, the width corresponding to the maximum inside diameter of the segment of enlarged cross section.

12. The device as claimed in claim 3, the diameter of the segment of enlarged cross section increasing and then decreasing from upstream to downstream.
